(19) United States
(12) Patent Application Publication
(10) Pub. No.: US 2010/0262722 A1
(43) Pub. Date: Oct. 14, 2010

(54) Dynamic Assignment of Graphics Processing Unit to a Virtual Machine

(76) Inventors: Christophe Vauthier, Bristol (GB); Chris I. Dalton, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/422,066

(22) Filed: Apr. 10, 2009

(51) Int. Cl. G06F 3/00; G06F 9/455; G06F 13/28

(52) U.S. Cl. 710/8; 718/1; 710/22

(57) ABSTRACT

In a virtualized computer system in which a plurality of virtual machines run on a platform that includes a hardware graphics processing unit (‘GPU’), provision is made for dynamically assigning the GPU to a selected one of the virtual machines. To this end, each virtual machine comprises, in addition to a guest operating system, a virtual bus with a hot-pluggable slot, and a virtual first configuration-management component responsive to events relevant to the hot-pluggable slot to interact with a second configuration-management component provided as part of the guest operating system of the virtual machine. To assign the GPU to a selected virtual machine, an emulated slot insertion event is generated in respect of the virtual hot-pluggable slot of the selected virtual machine thereby causing the first configuration-management component of that machine to trigger the guest operating system of the first virtual machine to operatively engage with the GPU.

### BACKGROUND

Virtualization of a computer involves the creation and management of one or more distinct software environments or “virtual machines” (VMs) that each emulate a physical machine. The physical hardware and software that support the VMs is called the host system or platform while the VMs are called guest systems.

FIG. 1 of the accompanying drawings depicts the general logical configuration of a virtualized computer system 10 in which three VMs 13A, 13B, 13C are supported by a host system that, in general terms, comprises host platform hardware 11 running a software layer 12 in charge of virtualization, called a virtual machine monitor (VMM) or hypervisor. Each VM 13A, 13B, 13C comprises a respective virtual platform 14A, 14B, 14C running a respective guest operating system (OS) 15A, 15B, 15C and one or more guest applications (APPS) 16A, 16B, 16C. The guest OSs 15A, 15B, 15C may be the same as each other or different. The VMM 12 is operative to cause each of the virtual platforms 14A, 14B, 14C to appear as a real computing platform to the associated guest OS 15A, 15B, 15C.

Of course, the physical resources of the host system have to be shared between the guest VMs and it is one of the responsibilities of the VMM to schedule and manage the allocation of the host platform hardware resources for the different VMs. These hardware resources comprise the host processor 17, memory 18, and devices 19 (including both motherboard resources and attached devices such as drives for computer readable media). In particular, the VMM is responsible for allocating the hardware processor 17 to each VM on a time division basis. Other responsibilities of the VMM include the creation and destruction of VMs, providing a control interface for managing the VM lifecycle, and providing isolation between the individual VMs.

FIG. 1 is intended to represent a virtualized system in very general terms; in practice, there are various types of virtualized system (also called ‘VM system’) according to the location of the VMM. Referring to FIG. 2 of the accompanying drawings, stack 20 represents a traditional non-virtualized system in which an operating system runs at a higher privilege than the applications running on top of it. Stack 21 represents a native VM system in which a VMM runs directly on the host platform hardware in privileged mode; for a guest VM, the guest machines' privileged mode has to be emulated by the VMM. Stack 22 represents a hosted VM system in which the VMM is installed on an existing platform. Other, hybrid, types of VM system are possible and one such system based on the Xen software package is outlined hereinafter.

Regarding how the VMM 12 makes each virtual platform 14A, 14B, 14C appear like a real platform to its guest OS, a number of general points may be noted:
Each VM will generally use the same virtual address space as the other VMs and it is therefore necessary to provide a respective mapping for each VM, for translating that VMs virtual addresses to real hardware addresses.
Although it is possible to simulate any processor for which a guest OS has been designed, it is generally more efficient to allow the guest OS instructions to be run directly on the host processor; this is only possible, of course, where the guest OS has the same ISA (Instruction Set Architecture) as the host.
Hardware resources, other than the processor and memory, are generally modeled in each virtual platform using a device model; a device model keeps state data in respect of usage of virtual hardware devices by the VM concerned. The form of these device models will depend on whether full virtualization or paravirtualization (see below) is being implemented.

A number of different approaches to virtualization are possible, and these are briefly described below.

In full virtualization, a VM simulates enough hardware to allow an unmodified guest OS, with the same ISA as the host, to run directly on the host processor. To ensure proper isolation, it is necessary to intercept sensitive instructions from the guest OS that would have an effect outside the VM concerned, such as I/O instructions, or instructions that could weaken the control of the VMM or impinge on other VMs.

Full virtualization is only possible given the right combination of hardware and software elements; full virtualization was not quite possible with the Intel x86 platform until the 2005-2006 addition of the AMD-V and Intel VT extensions (however, a technique called binary translation was earlier able to provide the appearance of full virtualization by automatically modifying x86 software on-the-fly to replace sensitive instructions from a guest OS).

The addition of hardware features to facilitate efficient virtualization is termed “hardware assisted virtualization”. Thus the AMD-V and Intel VT extensions for the x86 platform enables a VMM to efficiently virtualize the entire x86 instruction set by handling these sensitive instructions using a classic trap-and-emulate model in hardware, as opposed to software.

Hardware assistance for virtualization is not restricted to intercepting sensitive instructions. Thus, for example, as already noted, in a virtualized system all the memory addresses used by a VM need to be remapped from the VM virtual addresses to physical addresses. Whereas this could all be done by the VMM, hardware features can advantageously be used for this purpose. Thus, when establishing a new VM, the VMM will define a context table including a mapping between the VM virtual addresses and physical addresses; this context table can later be accessed by a traditional memory management unit MMU to map CPU-visible virtual addresses to physical addresses.

Instead of aiming for the goal of leaving the guest OS unmodified as in full virtualization, an alternative approach, known as “paravirtualization”, requires some modification of a guest OS. In paravirtualization the VMM presents a software interface to virtual machines that is similar but not identical to that of the underlying hardware allowing the VMM to be simpler or virtual machines that run on it to achieve performance closer to non-virtualized hardware.

Hardware-assisted virtualization can also be used with paravirtualization to reduce the maintenance overhead of paravirtualization as it restricts the amount of changes needed in the guest operating system.

Virtualization of the host platform hardware devices can also follow either the full virtualization (full device emulation) or paravirtualization (paravirtual device) approach. With the full device emulation approach, the guest OS can still use standard device drivers; this is the most straightforward way to emulate devices in a virtual machine. The corresponding device model is provided by the VMM. With the paravirtual device approach, the guest OS uses paravirtualized drivers rather than the real drivers. More particularly, the guest OS has “front-end drivers” that talk to “back-end drivers” in the VMM. The VMM is in charge of multiplexing the requests coming from and to the guest domains; generally, it is still necessary to provide a device model in each VM.

Hardware assistance can also be provided for device virtualization. For example, the above mentioned VM context table that provides a mapping between VM virtual addresses and real host-system addresses can also be used by a special hardware input/output memory management unit (IOMMU) to map device-visible virtual addresses (also called device addresses or I/O addresses) to physical addresses in respect of DMA transfers.

It will be appreciated that the sharing of devices between VMs may lead to less than satisfactory results where a guest application calls for high performance from a complex device such as a graphics processing unit.

### BRIEF DESCRIPTION OF THE DRAWINGS

Embodiments of the invention will now be described, by way of non-limiting example, with reference to the accompanying diagrammatic drawings, in which:

FIG. 1 is a diagram depicting a known general logical configuration of a virtualized computer;

FIG. 2 is a diagram showing the privilege levels of components of known non-virtualized and virtualized systems;

FIG. 3 is a diagram depicting a virtualized system based on the known Xen software;

FIG. 4 is a diagram of how a graphics card can be shared between virtual machines in the FIG. 3 system;

FIG. 5 is a diagram illustrating the main components involved in a known ACPI implementation;

FIG. 6 is a diagram showing the main operations occurring in response to a card insertion event in a known ACPI-compliant non-virtualized system;

FIG. 7 is a diagram of an embodiment of the invention showing the principal components involved in enabling dynamic assignment of a graphics card between virtual machines;

FIG. 8 is a diagram depicting, for the FIG. 7 embodiment, the main steps involved when de-assigning the graphics card from a first virtual machine; and

FIG. 9 is a diagram depicting, for the FIG. 7 embodiment, the main steps involved when assigning the graphics card to a second virtual machine.

### DETAILED DESCRIPTION

The embodiments of the invention described below enable a VM to be provided with high performance graphics via graphics hardware that can be dynamically assigned to different VMs.

The embodiments will be described in the context of a virtualized system based around the Xen virtualization software and therefore a brief outline of such a system will first be given.

Xen-Based Virtualized System

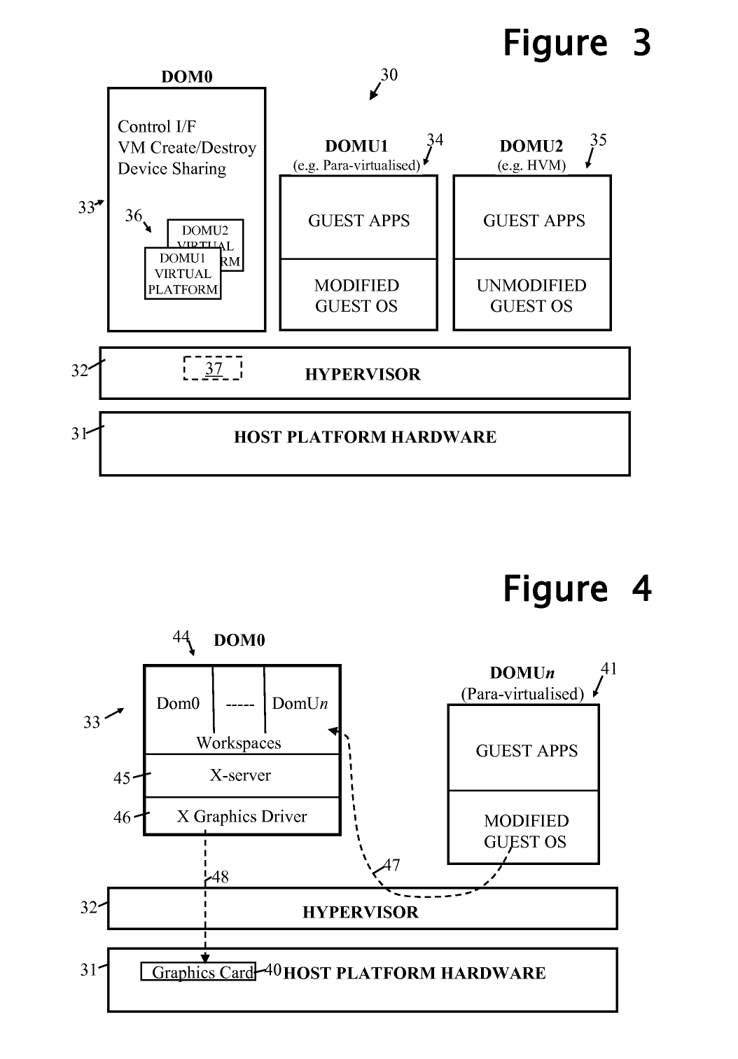

Xen is an open source paravirtualizing virtual machine monitor (usually called a hypervisor in the Xen context) for the Intel x86 processor architecture. Since version 3, Xen supports the Intel VT-x and AMD-v technologies. Xen is mostly programmed in the C language. FIG. 3 depicts a Xen hypervisor 32 running on platform hardware 31.

In the Xen terminology, a guest virtual machine is called a guest domain and three such domains 33-35 are shown in FIG. 3. The hypervisor 32 has the most privileged access to the system. At boot time, the hypervisor 32 is loaded first and then a first domain 33 is started, called “domain0” (often abbreviated to ‘Dom0’). Dom0 has an access to the entire hardware and is used to manage the hypervisor 32 and the other domains.

Once Xen is started, the user can create other guest domains which are referred to as unprivileged domains and usually labeled as domainU1, domainU2 . . . domainUn (abbreviated to DomU1 etc.); in the FIG. 3 example, domains 34 and 35 are respectively constituted by unprivileged domains DomU1, DomU2.

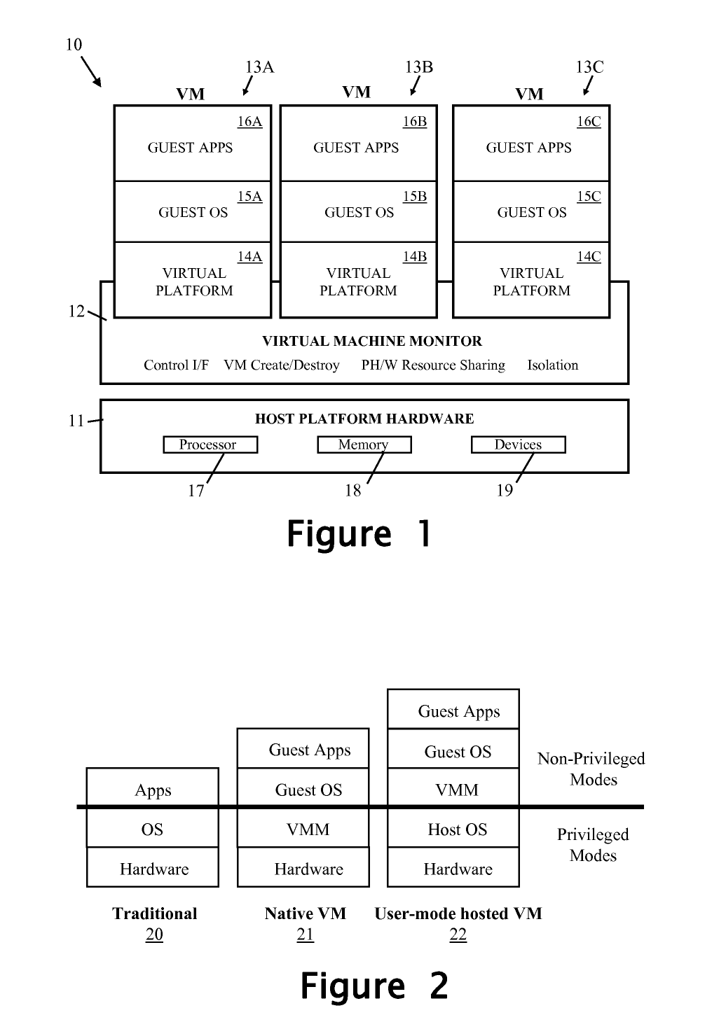

Domain0, which is a Linux paravirtualized kernel, can be considered as a management domain because the creation of new domains and hypervisor management are done through this domain. With reference back to FIG. 2, Xen can be thought of as a hybrid of a native VM system and a user-mode hosted VM system as the VMM functions of the generalized virtual system of FIG. 1 are divided between the privileged hypervisor 32 and domain0. As depicted in FIG. 3, the software objects giving substance to the virtual platforms 36 of the unprivileged domains, including their device models, are mostly located within domain0 (for efficiency reasons, certain device models, such as for the real-time clock, are actually located within the hypervisor layer 32).

A domainU can be run either as a paravirtualized environment, (e.g. domain 34 in FIG. 3), or as a fully virtualized environment (e.g. domain 35 in FIG. 3)—as the latter requires the hardware assistance of VT-x or AMD-v technology, such a domain is sometimes called a ‘hardware VM’ or ‘HVM’).

Regarding how to manage graphics and share display hardware between domains in a Xen-based virtualized system, a number of different approaches are known. Referring to FIG. 4 (which shows a Xen-based virtualized system with a graphics card 40 forming part of the platform hardware 31), Xen traditionally uses an X-server 45 in domain0 to service paravirtualized guest domains such as domain 41. Domain 41 passes its graphics output (dotted arrow 47) to a corresponding work space of the X-server 45 which is responsible for sharing the underlying hardware resource (graphics card) 40 between the paravirtualized domains. The X-server controls the graphics card 40 through a graphics driver 46. While this approach works well so far as sharing the graphics resource between the domains is concerned, it is not very effective from a performance standpoint. Similarly, the approach used for HVM guest domains of emulating a virtual VGA graphics card to the host OS, is also not very efficient.

Embodiments of the invention are described below which provide substantially full graphics performance to a VM by directly assigning a hardware graphics processing unit (‘GPU’) to the VM, giving it exclusive and direct access to the GPU; provision is also made for dynamically re-assigning the GPU to a different VM without shutting down either the original or new VM to which the GPU is assigned or interfering with the normal behaviour of their guest operating systems.

The direct assignment of a GPU to a specific VM can be performed by using the virtualization technologies now provided through hardware-based virtualization such as Intel VT-d or AMD IOMMU technology.

The dynamic reassignment of the GPU between VMs is performed using hotplug capabilities provided by a per VM emulation of a configuration management system such as ACPI (“Advanced Configuration and Power Interface”). In order to enable a better understanding of this aspect of the embodiments to be described hereinafter, a brief description will first be given of how ACPI (as an example configuration management system) operates in a non-virtualized system.

Advanced Configuration and Power Interface

The ACPI specification was developed to establish industry common interfaces enabling robust OS-directed motherboard device configuration and power management of both devices and entire systems. ACPI is the key element in OS-directed configuration and Power Management (i.e. OSPM). The ACPI specification mainly defines how hardware and operating systems should be “implemented” in order to correctly manage ‘Plug and Play’ (‘PnP’) and power management functionalities, among other things.

In general terms, in a computer implementing the ACPI specification, platform-independent descriptions (termed “ACPI tables”) of its ACPI-compliant hardware components are stored on the computer; on start-up of the computer, the ACPI tables are loaded to build a namespace that describes each of the several ACPI-compliant hardware devices. Each ACPI table may include “control methods” that facilitate interaction with the ACPI-compliant hardware components.

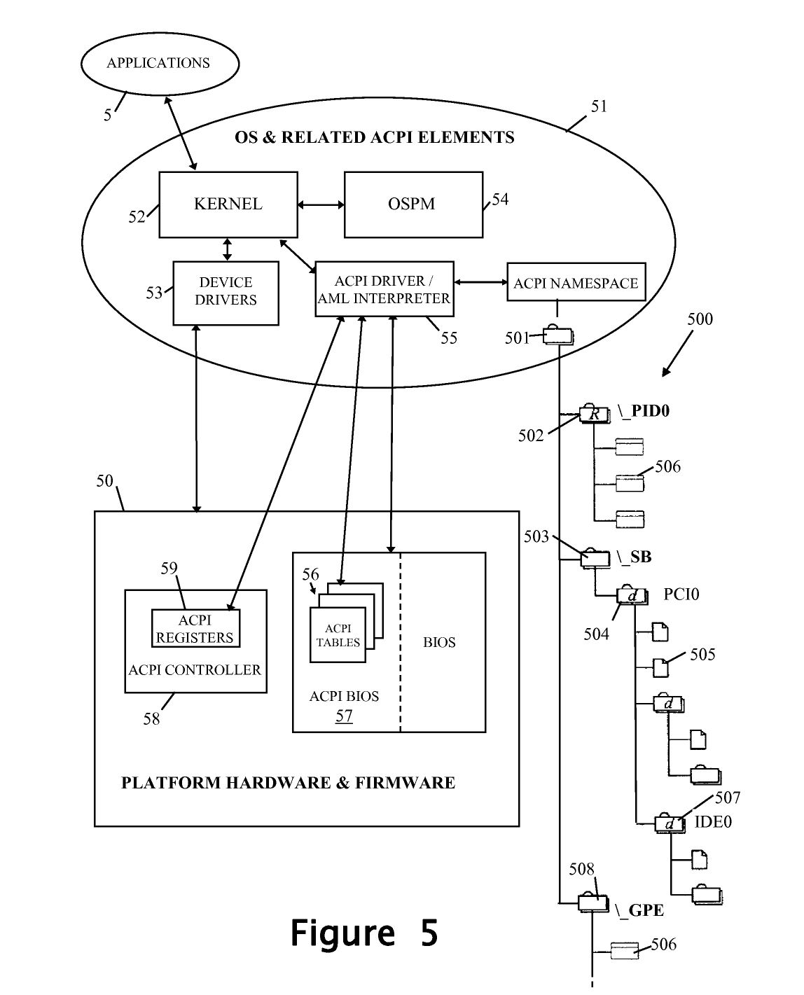

FIG. 5 depicts the main ACPI-related elements of an example ACPI implementation in a computer that comprises platform hardware and firmware 60, an operating system (OS) 51 and its related ACPI elements, and applications 5 running on top of the OS. The specific disposition of the ACPI elements is merely illustrative.

In standard manner, the OS 51 includes a kernel 52 one function of which is to pass information between the applications 5 and various device drivers 53 that enable the applications 5 to interact with hardware devices forming part of the platform hardware 60.

The main ACPI-related elements associated with the OS 51 is the Operating System Power Management (OSPM) 54 and the ACPI driver 55. The OSPM 54 comprises one or more software modules that may be used to modify the behavior of certain components of the computer system, for example, to conserve power in accordance with pre-configured power conservation settings.

The ACPI driver 55 provides an interface between the OS and the ACPI-related elements of the hardware and firmware (described below) and is also responsible for many ACPI-related tasks including populating an ACPI namespace 500 at system start-up. The OSPM 54 uses the ACPI driver 55 in its interactions with ACPI-related elements of the hardware and firmware 50.

The main ACPI-related elements associated with the hardware and firmware 50 are the ACPI BIOS 57, the ACPI tables 56 (here, shown as part of the ACPI BIOS though this need not be the case), an ACPI controller 58, and ACPI registers 59 (here shown as part of the controller 58 though, again, this need not be the case).

The ACPI BIOS 57 is part of the code that boots the computer and implements interfaces for power and configuration operations, such as sleep, wake, and some restart operations. The ACPI BIOS 57 may be combined with, or provided separately from, the normal BIOS code.

The ACPI tables 56 each comprise at least one definition block that contains data, control methods, or both for defining and providing access to a respective hardware device. These definition blocks are written in an interpreted language called ACPI Machine Language (AML), the interpretation of which is performed by an AML interpreter forming part of the ACPI driver 55. One ACPI table 57, known as the Differentiated System Description Table (DSDT) describes the base computer system.

Regarding the ACPI controller 58, one of its roles is to respond to events, such as the plugging/unplugging of a PCI card, by accessing the ACPI registers 59 and, where appropriate, informing the OSPM 54 through a system control interrupt (SCI). More particularly, the ACPI registers 59 include Status/Enable register pairs and when an event occurs the ACPI controller 58 sets a corresponding bit in the status register of an appropriate one of the Status/Enable register pairs; if the corresponding bit of the paired enable register is set, the ACPI controller 58 generates an SCI to inform the OSPM which can then inspect the Status/Enable register pair via the ACPI driver 55. An important Status/Enable register is the General Purpose Event (GPE) Status/Enable register pair, its registers being respectively called GPE_STS and GPE_EN; the GPE Status/Enable register pair is manipulated by the ACPI controller and the OSPM when a generic event occurs.

As already indicated, one of the roles of the ACPI driver 55 is to populate the ACPI namespace 500 at system start-up, this being done by loading definition blocks from the ACPI tables 56. A namespace object may contain control methods defining how to perform a hardware-related ACPI task. Once a control method has been loaded into the ACPI namespace 500, typically at system start up, it may be invoked by other ACPI components, such as the OSPM 54, and is then interpreted and executed via the AML interpreter.

The example ACPI namespace 500 shown in FIG. 5 includes a namespace root 501, subtrees under the root 501, and objects of various types. For instance, power resource object \_PID0 heads up a subtree under root 501; \_GPE object 508 heads up a subtree that includes control methods relevant to particular general purpose events; and \_SB system bus object 503 heads up a subtree that includes namespace objects which define ACPI-compliant components attached to the system bus (an example of such an object is the PCI0 bus object 504). Each namespace object may contain other objects, such as data objects 505, control methods such as 506, or other namespace objects (e.g., IDE namespace objects IDE0 507 under the PCI0 bus object 504).

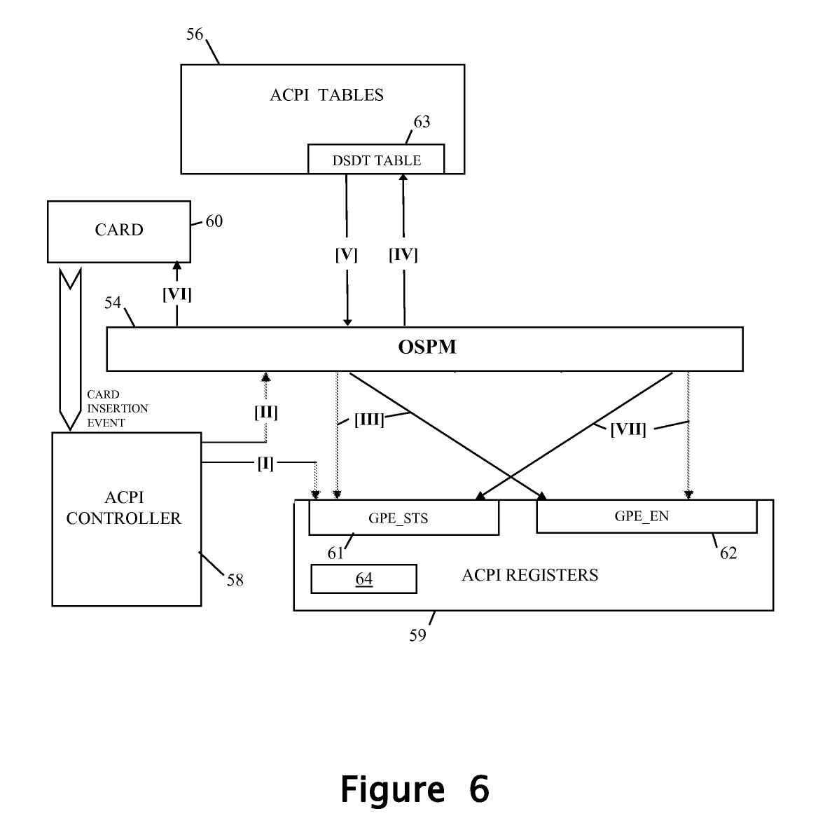

FIG. 6 illustrates an example of the interactions between the principle ACPI components upon the occurrence of a general purpose event, in this case the plugging in of a card 60 into a PCI bus slot (herein a ‘slot insertion’ event).

In FIG. 6, the ACPI driver is omitted for clarity, it being assumed that it has already built the ACPI namespace; the ACPI namespace is also not represented though the OSPM does use it to access an ACPI-table control method in the course of responding to the slot insertion event. The previously mentioned GPE status and enable registers GPE_STS and GPE_EN and the DSDT table, are all explicitly depicted in FIG. 6 and referenced 61,62 and 63 respectively. Also depicted is a register 64 used for indicating the slot number of a PCI slot where an event has occurred, and the nature (insertion/removal) of the event.

The interactions between the ACPI components upon occurrence of a slot insertion event are referenced [I]-[VII] and proceed as follows:
[I] When a card is inserted into a PCI slot, the ACPI controller 58 sets the slot ID and nature of the event into register 64 and then sets the appropriate bit of the GPE_STS register 61 to indicate a PCI bus slot related event has occurred.
[II] If the corresponding bit of the GPE_EN register is also set, the ACPI controller 58 then asserts an SCI to inform the OSPM 54 that something has just happened; however, if the corresponding bit of the GPE_EN register is not set, no SCI is asserted.
[III] Assuming an SCI is asserted, the OSPM 54 responds by reading the GPE_STS register 61 to ascertain which bit has been set. The OSPM 54 also clears the corresponding bit of the GPE_EN register thereby temporarily disabling the interrupt source in order not to be disturbed again with this type of event until it has finished processing the current event.
[IV] The OSPM 54 invokes the appropriate control method from the DSDT table 63. (In this respect, it may be noted that there is an ACPI naming convention that allows OPSM to know which ACPI control method to execute according to the position of the GTE_STS register bit that has been set. For example, if the bit 3 of GPE_STS register has been set, the OSPM 54 will invoke the control method called GPE._L03). In this case, the control method ascertains from the register 64 the slot concerned and the nature of the event (in this example, slot insertion).
[V] The control method generates a new SCI to notify the OSPM.
[VI] As a card has been plugged in, the operating system sets up the device carried on the card and loads the appropriate driver.
[VII] The OSPM 54 then clears the appropriate bit of the GPE_STS register 61 and re-enables the interrupt source by setting the corresponding bit in the GPE_EN register 62.

A similar sequence of operations is effected when a user indicates that the device is to be removed (a removal event), the equivalent operations of [VI] above involving the operating system closing all open descriptors on the device and unloading the driver.

### Embodiment

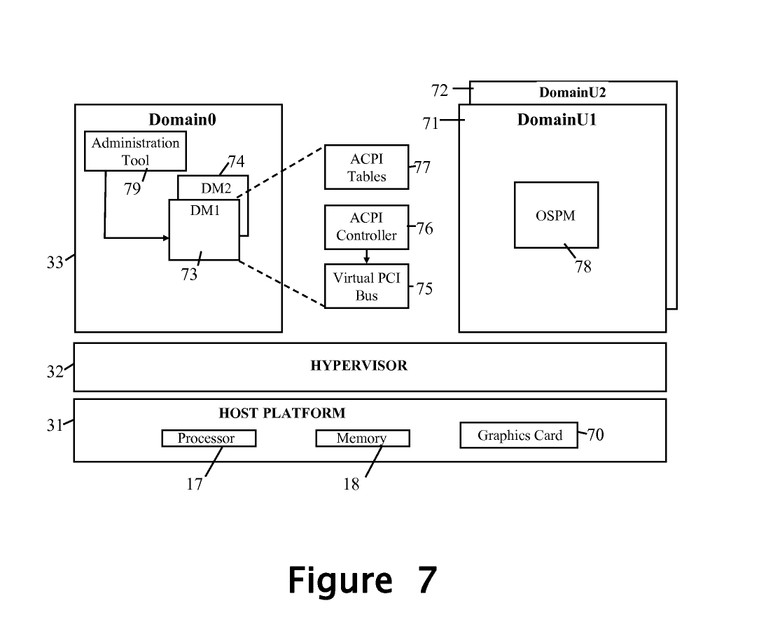

An embodiments of the invention will next be described, with reference to FIGS. 7 to 9, for a virtualized system based around the Xen virtualization software and ACPI-compatible guest operating systems, it being appreciated that different forms of virtualized platforms could alternatively be employed and the guest operating systems may use a different configuration management system in place of ACPI.

FIG. 7 depicts a Xen-based virtualized system with hardware-assisted virtualization. Hypervisor 32 runs on top of the host platform 31 that includes a processor 17, memory 19, and a graphics card 70 providing a GPU; in this example, the platform 31 is an x86 platform with hardware-assisted virtualization provided by AMD-V or Intel VT extensions. Memory 18 is here taken to include both non-volatile and volatile components, as appropriate, for storing program instructions (including BIOS code, hypervisor code, guest OS code, etc) and data; memory 18 is an example ‘computer readable media’, this term also covering transport media such as optical discs for supplying programs and data to the FIG. 7 system (via an appropriate media-reading interface).

On system start up, the hypervisor 32 boots the special virtual machine 33 (the domain0) which is used to create and manage other, unprivileged, VMs—two such VMs are depicted in FIG. 7, namely VM 71 (designated DomU1) and VM 72 (designated DomU2 which in the present example are hardware VMs. For each of the unprivileged VMs 71, 72, an emulated platform (emulated PCI bus, IDE controller, ACPI controller, etc. . . ) is provided by a respective process 73, 74, known as the device model or DM, running in domain0.

The principle elements of each device model that are of relevance to the dynamic assignment of the GPU 70 between VMs (domains 71, 72) are:
Virtual PCI bus 75
ACPI tables 76,
ACPI controller 77
   shown in FIG. 7 in respect of the device model DM1 73 of domain U1. Also of interest is the OSPM 78 of the guest operating system of each unprivileged domain 71, 72.

For any one VM 71, 72, the GPU (graphics card 70) can be exclusively assigned to that VM by:
modifying the virtual PCI bus implementation provided to the VM in order to support the attachment of a real device to the device tree;
modifying the device model implementation to use the real GPU (graphics card) 70;
modifying the device model implementation to use the VGA BIOS of the real graphics card instead of the emulated one.
   Primarily this involves ensuring that the appropriate memory mappings (OS virtual address space to real hardware address space) are in place to point to the GPU (graphics card) 70 and for the hardware IOMMU to effect appropriate address translations for DMA transfers. The mappings can be provided just for the VM to which the GPU is assigned and removed when the GPU is de-assigned from that VM or the mappings can be provided for all VM regardless of which VM is currently assigned the GPU—in this latter case, it is, of course, necessary to ensure that the guest operating systems of the VMs to which the GPU is not assigned cannot use the mappings (the IOMMU effectively does this). Another option is to keep the mappings for the VMs not assigned the GPU but to redirect them to a ‘bit bucket’.

With regard to what needs to be done to make the GPU 70 dynamically assignable through the use of ACPI hotplug features, this involves:
modifying the ACPI tables 77 to make a specific virtual PCI slot “hot pluggable and hot removable” (the hardware graphics card can then be attached to this virtual slot);
modifying the ACPI controller 76 to enable it to be virtually triggered by a virtual PCI bus slot event;
adding a new management command (in administration tool program 79 running in domain0) that allows the user to disconnect the GPU from one VM (e.g. VM 71) and connect it to a different, user-selected, virtual machine (e.g. VM72).

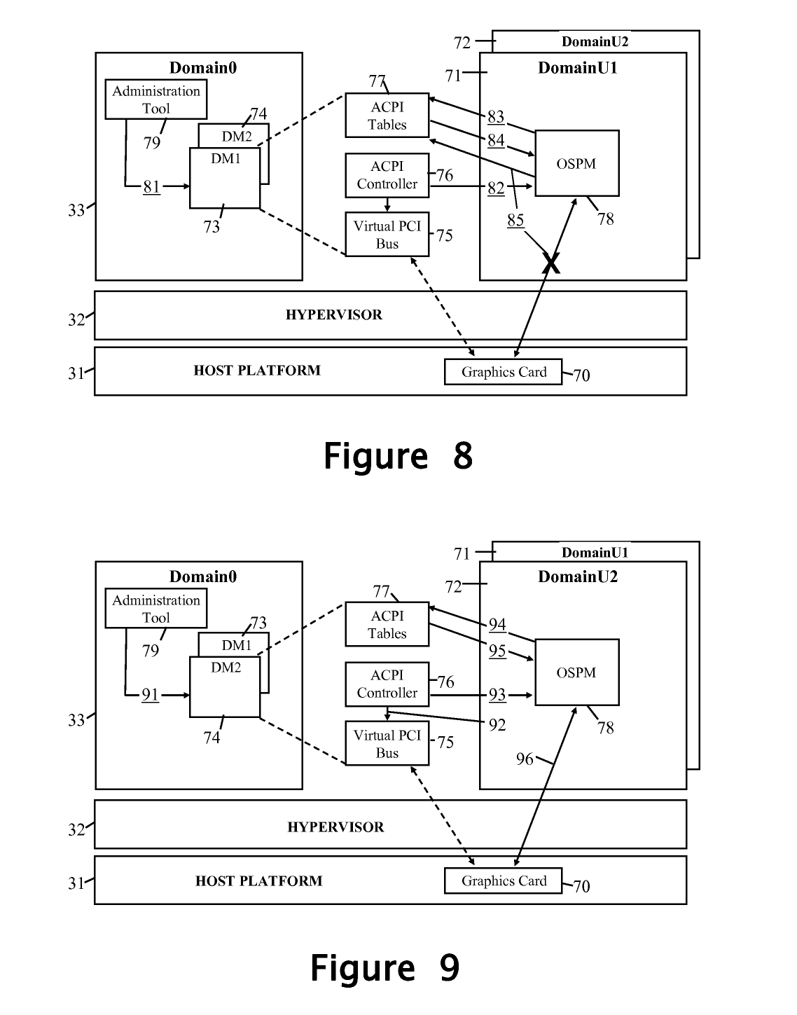

FIG. 8 shows the different steps performed when disconnecting the GPU (graphics card) 70 from VM 71 (DomainU1).
Step 81 When the user wants to disconnect the GPU 70 from a virtual machine, he/she executes the appropriate administration command (using tool 79) simulating, to the virtual ACPI controller 76 of DM 73, an unplug (‘removal’) event on the hot-pluggable virtual slot of the virtual PCI bus 75.
Step 82 The ACPI controller 76 sends a SCI signal to OSPM 78.
Step 83 OSPM 78 executes the corresponding control method from the ACPI tables 77.
Step 84 At the end of the control method, another SCI signal is sent to the OSPM 78 to specify that the event is actually a request for removing the device (the GPU) in the hot-pluggable slot.
Step 85 The operating system then operatively disengages from the GPU 70 by closing all descriptors open on the GPU and unloading its driver. OSPM 78 now calls a specific ACPI control method to inform the system that the device can safely be removed.
   From this point, the GPU 70 can be assigned to another virtual machine.

FIG. 9 shows the different steps performed when connecting the GPU 70 to VM72 (DomainU2):
Step 91 When the user wants to connect the GPU 70 to VM 72, he/she executes the appropriate administration command (using tool 79) simulating, to the ACPI controller 76 of DM 74, a plug (‘insertion’) event on the hot-pluggable virtual slot of the virtual PCI bus 75.
Step 92 The ACPI controller 76 first attaches the GPU 70 to the virtual PCI bus 75 associated with VM 72 and initializes the slot.
Step 93 From this point, the GPU 70 is visible to VM 72. The ACPI controller 76 sends an SCI signal to OSPM 78 of VM 72.
Step 94 OSPM 78 then executes the appropriate control method in the ACPI tables 77.
Step 95 At the end of the control method, another SCI signal is sent to OSPM 78 to specify that the event is actually a request to plug in a new device.
Step 96 The guest operating system of VM 72 now proceeds to operatively engage with the GPU 70 including by automatically setting up the GPU 70 and loading the appropriate driver.

Although only two VMs 71, 72 have been shown in FIGS. 7-9, it will be appreciated that the GPU (graphics card) 70 can be dynamically assigned between any number of VMs.

The above-described embodiment enables the graphics hardware to be dynamically assigned to any desired virtual machine without compromising graphics performance and thus, the user experience. This is achieved outside of each operating system i.e. within the virtual machine monitor. Hence, the guest operating systems require no additional software module (the OSPM already being a standard part of most operating systems).

It may be noted that for the VMs to which the GPU is not assigned, an emulated visual output device can be provided in the device model (though this is not necessary from a technical point of view, it is desirable from a usability point to view).

As already indicated, although the above-described embodiments of the invention concerned a virtualized system based around the Xen virtualization software and ACPI-compatible guest operating systems, different forms of virtualized platforms could alternatively be employed and the guest operating systems may use a different configuration management system in place of ACPI. Furthermore, although in the described embodiment, hardware assistance is provided (in particular for address translation in respect of DMA transfers involving the GPU), other embodiments may rely on software-based memory translation, though this is less efficient. The dynamically-assigned GPU need not be provided on a graphics card 70 but could be on the platform motherboard, it being appreciated that this does not prevent the GPU being treated as a hot pluggable device so far as the virtual machines are concerned.

1. A method of dynamically assigning a hardware graphics processing unit, GPU, to a selected virtual machine of a virtualized computer system, the method comprising:
(a) providing a plurality of virtual machines on a computer platform including the hardware GPU, each virtual machine comprising a guest operating system, a virtual bus with a hot-pluggable slot, and a virtual first configuration-management component responsive to events relevant to the hot-pluggable slot to interact with a second configuration-management component provided as part of the guest operating system of the virtual machine; and
(b) assigning the GPU to a first selected one of the virtual machines by generating an emulated slot insertion event in respect of the virtual hot-pluggable slot of the first virtual machine to cause the first configuration-management component of that machine to trigger the guest operating system of the first virtual machine to operatively engage with the GPU through a provided mapping between the virtual address space of the virtual machine and the real address space of the computer platform.

2. A method according to claim 1, further comprising re-assigning the GPU from the first selected virtual machine to a second selected virtual machine by:
de-assigning the GPU from the first virtual machine by generating an emulated slot removal event in respect of the virtual hot-pluggable slot of the first virtual machine to cause the first configuration-management component of the first virtual machine to trigger the guest operating system of the first virtual machine to operatively disengage from the GPU; and
repeating (b) but in respect of the second selected virtual machine rather than the first selected virtual machine.

3. A method according to claim 1, wherein the first and second configuration-management components are ACPI compliant.

4. A method according to claim 3, wherein the first configuration-management component is a virtual ACPI controller and the second configuration-management component is an OSPM component of the guest operating system.

5. A method according to claim 1, wherein (a) includes running a Xen-based virtual machine monitor to provide a management domain and a respective unprivileged domain for each virtual machine, and further wherein in (b) the generation of said slot insertion event is effected in response to user input received by an administration program running in the management domain.

6. A method according to claim 1, wherein the computer platform of the virtualized computer system provides hardware assistance for virtual to real memory address translation for DMA transfers involving the GPU.

7. A method according to claim 6, wherein the virtualized computer system comprises an x86 host platform with hardware-assisted virtualization provided by AMD-V or Intel VT extensions.

8. A method of dynamically re-assigning a hardware graphics processing unit, GPU, from a first virtual machine to a second virtual machine in a virtualized computer system, each virtual machine including a guest operating system, a virtual bus with a hot-pluggable slot, and a virtual first configuration-management component responsive to events relevant to the hot-pluggable slot to interact with a second configuration-management component provided as part of the guest operating system, and the virtual machine to which the GPU is assigned including a mapping enabling its guest operating system to directly interact with the GPU; the method comprising:
de-assigning the GPU from the first virtual machine by generating an emulated slot removal event in respect of the virtual hot-pluggable slot of the first virtual machine to cause the first configuration-management component of the first virtual machine to trigger the guest operating system of the first virtual machine to operatively disengage from the GPU; and
assigning the GPU to the second virtual machine by generating an emulated slot insertion event in respect of the virtual hot-pluggable slot of the second virtual machine to cause the first configuration-management component of that machine to trigger the guest operating system of the second virtual machine to operatively engage with the GPU.

9. A method according to claim 8, wherein the first and second configuration-management components are ACPI compliant.

10. A method according to claim 9, wherein the first configuration-management component is a virtual ACPI controller and the second configuration-management component is an OSPM component of the guest operating system.

11. A method according to claim 8, wherein the virtualized computer system runs a Xen based virtual machine monitor providing a management domain and a respective unprivileged domain for each virtual machine, the generation of said slot insertion and removal events between effected in response to user input received by an administration program running in the management domain.

12. A method according to claim 8, wherein a host platform of the virtualized computer system provides hardware assistance for virtual to real memory address translation for DMA transfers involving the GPU.

13. A method according to claim 8, wherein the virtualized computer system comprises an x86 host platform with hardware-assisted virtualization provided by AMD-V or Intel VT extensions, and a Xen based virtual machine monitor running on the host platform to provide a management domain and a respective unprivileged domain for each virtual machine; and further wherein the first and second configuration-management components are ACPI compliant.

14. A computer system comprising a processor, a graphics processing unit, GPU, and memory storing program instructions for execution by the processor to:
(a) provide a plurality of virtual machines each comprising a guest operating system, a virtual bus with a hot-pluggable slot, and a virtual first configuration-management component responsive to events relevant to the hot-pluggable slot to interact with a second configuration-management component provided as part of the guest operating system of the virtual machine; and
(b) assign the GPU to a first selected one of the virtual machines by generating an emulated slot insertion event in respect of the virtual hot-pluggable slot of the first virtual machine to cause the first configuration-management component of that machine to trigger the guest operating system of the first virtual machine to operatively engage with the GPU through a provided mapping between the virtual address space of the virtual machine and the real address space of the computer system.

15. A computer system according to claim 14, wherein the memory further stores program instructions for execution by the processor to:
de-assign the GPU from the first virtual machine by generating an emulated slot removal event in respect of the virtual hot-pluggable slot of the first virtual machine to cause the first configuration-management component of the first virtual machine to trigger the guest operating system of the first virtual machine to operatively disengage from the GPU; and
assign the GPU to a second selected one of the virtual machines by generating an emulated slot insertion event in respect of the virtual hot-pluggable slot of the second virtual machine to cause the first configuration-management component of that machine to trigger the guest operating system of the second virtual machine to operatively engage with the GPU through a provided mapping between the virtual address space of the virtual machine and the real address space of the computer system.

16. A computer system according to claim 14, wherein the first and second configuration-management components are ACPI compliant.

17. A computer system according to claim 16, wherein the first configuration-management component is a virtual ACPI controller and the second configuration-management component is an OSPM component of the guest operating system.

18. A computer system according to claim 14, wherein (a) provides a management domain and a respective unprivileged domain for each virtual machine, and further wherein in (b) the generation of said slot insertion event is arranged to occur in response to user input received by an administration tool running in the management domain.

19. A computer system according to claim 14, further comprising hardware assistance for virtual to real memory address translation for DMA transfers involving the GPU.

20. A computer system according to claim 19, wherein the computer system comprises an x86 host platform with hardware-assisted virtualization provided by AMD-V or Intel VT extensions.
